(19) United States
(12) Patent Application Publication
(10) Pub. No.: US 2003/0088794 A1
(43) Pub. Date: May 8, 2003

(54) Method and system for rendering secure pin entry

(75) Inventors: Leedor Agam, Tel Aviv (IL); Yanki Margalit, Ramat-Gan (IL); Dany Margalit, Ramat-Gan (IL)

Correspondence Address: DR. MARK FRIEDMAN LTD., C/O Mr. Bill Polkinghorn, Discovery Dispatch, 9003 Florin Way, Upper Marlboro, MD, 20772, US

(73) Assignee: ALADDIN KNOWLEDGE SYSTEMS LTD.

(21) Appl. No.: 10/287,689

(22) Filed: Nov. 5, 2002

Related U.S. Application Data
(60) Provisional application No. 60/338,238, filed on Nov. 5, 2001.

(51) Int. Cl. H04L 9/32

(52) U.S. Cl. 713/202

(57) ABSTRACT

The present invention is related to Secure PIN Entry in conjunction with security tokens. In one aspect, the present invention is directed to a method for securely providing a PIN to a security token. In another aspect, the present invention is directed to a method for securely providing a PIN by a security token to a host system. The PIN is rendered separately from the host, thereby the provision of the PIN is carried out in a secure manner, therefore cannot be “hacked”.

### FIELD OF THE INVENTION

The present invention relates to the field of security tokens. More particularly, the present invention relates to a method and system for rendering secure PIN entry in conjunction with security tokens.

### BACKGROUND OF THE INVENTION

The term PIN refers herein to a string of alphanumeric characters to be provided to an application in relevance with security. For example, personal identification number, pass phrase, password and a key for ciphering are examples for PINs.

Authentication is the action of verifying information such as identity, ownership or authorization. In private and public computer networks (including the Internet), authentication is commonly carried out through the use of logon passwords. Knowledge of the password is assumed to guarantee that the user is authentic. The weakness of passwords is that passwords can often be stolen, accidentally revealed, or forgotten. For this reason, Internet business and many other transactions require a more stringent authentication process.

Instead of typing a password, a biometric sample (e.g. fingerprint, voice, etc.) can be used for authenticating a user. The biometric sample can be converted eventually to a PIN.

Typically, an authentication process comprises two stages:

(a) Getting from the user to be authenticated an input signal (referred also as Authenticating Signal) which only an authentic user can provide; and

(b) Testing if the signal corresponds to a signal expected from an authentic user. Alternatively, instead of testing the signal, one or more characteristics of the signal can be processed. For example, as known to the skilled person, in fingerprint authentication some characteristics of the fingerprint image are derived from the fingerprint image, and these characteristics are used for authenticating the user.

The process of providing a PIN to a host system is known in the art as PIN Entry.

The term Security Token refers herein to a mobile device to be connected to a host system, for rendering security-related operations. A typical application for a security token is providing a PIN (e.g. password) to a host system. Instead of typing the PIN, the user plugs in the token into the appropriate socket of the host system, and the host system retrieves the PIN from the token.

One Factor Authentication

FIG. 1 schematically illustrates the communication between a security token and a host system, according to the prior art. The security token 20 is an external device to the host system 30. The communication between the security token and the host system is carried out via communication channel 30, which may be, for example, USB, RS232, and so forth. Upon inserting the security token 20 into the appropriate socket of the host system 10, the PIN is provided by the security token 20 to the host system 10. Such an authentication process is called in the art “One Factor Authentication”.

For example, authenticating a user by a host system can be carried out by a security token as follows: A unique PIN, which is associated with the user, is pre-stored within the security token. Additionally the host system maintains a database in which a list of the authorized users and their associated PINs is stored. Setting the security token into the appropriate socket of the host system enables the host system to communicate with the security token. During the communication session the host retrieves the PIN from the token, and compares it to the PINs stored within the database. If the PIN matches to a stored PIN, then the user is positively authenticated. Higher security level can be achieved by implementing One-Time-Password and other methods known in the art.

Of course instead of storing a PIN within the security token, the PIN can be generated by the computing facilities of the security token. Moreover, more sophisticated PINs can be generated, such as One-Time-password.

The recent generation of security tokens are coupled with generic processing means (e.g. smartcard), which are “separated” from their host system (i.e. connected by controlled communication means to the host system), and therefore enable processing in a quite secure manner. A typical implementation which uses this benefit is digitally signing a document. The document is conveyed to the security token, where the digital signature is generated, and thereafter conveyed to the host system. Since the processing involved is carried out “separately” from the host system, it is out of the reach of a malicious facility running on the host system.

Enhancing the One-Factor Authentication

The form of providing a PIN by a security token enables using longer PINs in comparable to typing a PIN by the user, thus gaining a higher security level. Moreover, since the security token is actually a microprocessor, more sophisticated PINs can be obtained, such as the One-Time-password.

An example of security token is the eToken, manufactured by Aladdin Knowledge Systems. From the hardware point of view, the security token is a microcomputer connected to a host system via wired communication. From the functionality point of view, the device is applicable for security purposes, such as a gateway from which a PIN is provided to the host system.

Two-Factor Authentication

There is a drawback in using of security token since such a device can be used by anyone who holds it, including unauthorized persons. In order to prevent this possibility, the user has to be authenticated prior to providing a key to the host system.

Another example for this mechanism can be illustrated by the following example. Digitally signing an electronic document requires a key, which can be provided by a security token (the key can be considered also as a PIN). In order to achieve higher security level, the user is authenticated prior to providing the key by the security token to the host system. Typically, the authentication is carried out by providing an The PIN which is used for authenticating the user is referred herein as authenticating PIN.

In order to distinguish between the PIN used for authenticating the user, and the PIN requested by the host system, the first pin is referred herein Authenticating PIN, and the second PIN is referred herein as Requested PIN.

FIG. 2 is a flowchart of a PIN Entry mechanism which is carried out through a security token, according to the prior art. Two stages are involved in the provision of a PIN (the Requested PIN):

(a) Authenticating the user by the security token (by providing an Authenticating PIN); and

(b) Upon positive authentication, releasing the Requested PIN by the security token to the host system.

Since the security token has no input means (e.g. keyboard), in the prior art the input of the Authenticating PIN is carried out via the input means of the host system, and then sent to the security token. Thus, the host system is used as a part of the PIN Entry mechanism, and hence the provided PINs are exposed to “hacking”.

At the host system:

At step 100, an application (being executed on a host system) that requires a key displays an input window for entering an Authenticating PIN.

At step 101, the user enters the Authenticating PIN through the host system input means (e.g. keyboard).

At step 102, the Authenticating PIN is sent from the host system to the security token.

At the security token:

At step 103, the user is authenticated by the Authenticating PIN.

At step 104, if the user has been positively authenticated, then the control continues at step 105, where the Requested PIN is returned to the host system. Otherwise, the control continues at step 106, where an invalidity code is returned to the host system.

As mentioned above, the drawback of PIN Entry mechanisms in which the Authenticating PIN is entered via the input means of the host system is that the Authenticating PIN is exposed to “hacking”. Those skilled in the art will appreciate that a well known method for “hacking” is by intercepting the input data and output data of software and hardware modules. Thus, even if the communication channel between the host system and the security token is secure (e.g. encrypted), the Authenticating PIN is still exposed to hacking. Moreover, if the user has to type the Authenticating PIN, the key strokes can be also intercepted. Those skilled in the art will appreciate that there are additional hacking methods known in the art.

It is therefore an object of the present invention to provide a method and system for rendering a Secure PIN Entry in conjunction with a security token. Other objects and advantages of the invention will become apparent as the description proceeds.

### SUMMARY OF THE INVENTION

In one aspect, the present invention is directed to a method for securely providing a PIN to a security token being connected as a separate device to a host system, comprising: providing means for rendering the PIN, the means being separate to the host system; rendering the PIN by the means; and providing the rendered PIN to the security token; thereby securely providing the PIN to the security token. The means for rendering the PIN may also be separated from the security token and conveyed to the security token via data communication means.

Rendering the PIN is carried out by, e.g., retrieving the PIN from a pre-stored memory, inputting the PIN by a user, inputting a biometric input and converting the input to a PIN, and generating the PIN by processing. The input means can be, e.g., a keyboard, a remote keyboard, a personal handheld device, and biometric input means.

In another aspect, the present invention is directed to a method for securely providing a PIN by a security token to a host system, comprising the steps of: providing separate authenticating means to the host system, for authenticating users; authenticating a user by the authenticating means; in response to positively authenticating the user, providing the PIN by the security token to the host system; and/or in response to failing to authenticate the user, sending by the security token to the host system an acknowledgement therefor; thereby securely providing the PIN to the host system.

According to one embodiment of the invention, authenticating a user is carried out by: inputting an authenticating signal from the user; and testing if the authenticating signal corresponds to a signal expected from an authentic user. The authenticating process may be fully carried out by the security token, or partly carried out by the security token and partly carried out by a separate device to the security token and to the host system. Also the authenticating process can be carried out by one or more separate devices to the security token, and the one or more separate devices to the security token connected by communication means to the security token.

In another aspect, the present invention is directed to a system for securely providing a PIN to a host system through a security token, comprising: input means, for inputting an authenticating signal from a user to be authenticated; and/or testing means, for testing the correspondence of the authenticating signal to a signal expected from an authentic user; the input means and/or the testing means being separate to the host system, thereby securely providing the PIN to the host system. The security token may be used as the platform to the input means and/or the testing means.

The system may further comprise: a separate device to the security token, for hosting the input means and/or for hosting the testing means, and communication means for communicating with the security token; communication means on the security token, for communicating with the separate device.

The input means may be, for example, a keyboard, a remote keyboard, a personal handheld device, and biometric input means. The biometric input may be, for example, voice, fingerprint, image, and retina. The testing means may be, for example, an executable computer code.

### BRIEF DESCRIPTION OF THE DRAWINGS

The present invention may be better understood in conjunction with the following figures:

FIG. 1 schematically illustrates the communication between a security token and a host system, according to the prior art.

FIG. 2 is a flowchart of a PIN Entry mechanism which is carried out through a security token, according to the prior art.

FIG. 3 schematically illustrates a security token coupled with a keypad as input means, according to a preferred embodiment of the invention.

FIG. 4 schematically illustrates elements involved in a PIN Entry process, according to another preferred embodiment of the invention.

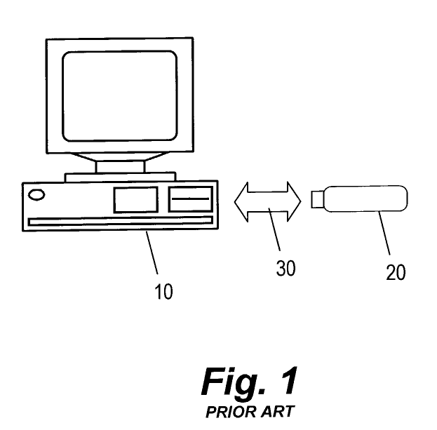

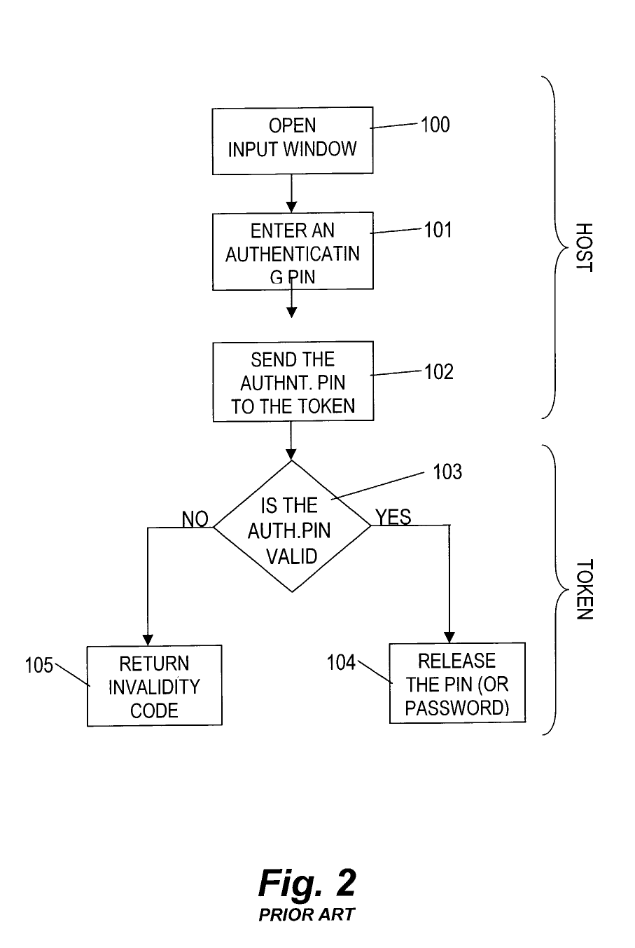

### DETAILED DESCRIPTION OF PREFERRED EMBODIMENTS

The present invention deals with carrying out a Secure PIN Entry in conjunction with security tokens. Typically the present invention is implemented in a platform where the provision of a Requested PIN is carried out by two stages:

(a) Authenticating a user by the security token.

(b) After a positive authentication, providing the Requested PIN by the security token to the host system.

As mentioned above, an additional PIN may be involved in stage (a), where the user is authenticated by the security token. The PIN which is used for authenticating the user is referred herein as Authenticating PIN.

According to a preferred embodiment of the present invention, in order to prevent “hacking” of the Authenticating PIN and/or the Requested PIN, the authentication process is kept “outside” the host system. Thus, the Authenticating PIN and/or the authenticating process therefor should be kept “outside” the host system.

One way for achieving this purpose is avoiding using the memory of the host system by the authenticating process and/or for storing the Authenticating PIN. Another way for achieving this purpose is to perform the authenticating process by an “external” device to the host system (i.e. a device which is connected to the system by communicating means).

Thus, the term “separate device to a system”, “a device separated from a system”, and so forth refer herein to a device which has no access to the memory of the host system, and/or being connected to the host system only by controlled communication means. Thus, the connection between a “separate” device of a host system and its host system is under control, thereby enabling secure communication between the device and its host.

As mentioned above, the authentication comprises two stages—getting an input signal from the user, and testing the signal for determining if the signal corresponds to a signal expected from an authentic user. For carrying out these stages, two facilities are required—an input facility, for inputting the signal, and a testing facility, for testing the signal.

According to a preferred embodiment of the invention, the security token is provided with both, the input facility and the testing facility. According to another preferred embodiment of the invention, the security token is provided only with one facility, while the function of the other facility is carried out by an external device to the security token, and then transmitted to the security token. In this case the security token should be provided with communication means with said external facility.

For example, the input of the Authenticating PIN may be carried out by a wireless keyboard to the security token. Thus, the security token should be coupled with means for communicating with the remote keyboard, which is connected to the security token by wireless communication means.

Alternatively, the security token can be coupled with input means, and the testing means may be external to the security token, e.g., a PDA which is coupled with processing means.

According to another preferred embodiment of the invention, the whole authenticating stage is carried out by an external device to the security token, and the result of the authentication is transmitted to the security token. For example, the authentication of the user is carried out by a PDA (input and testing), and upon positively authenticating a user, a code (i.e. a PIN) is transmitted to the security token, which triggers the provision of the Requested PIN by the security token to the host system.

According to one embodiment of the invention, the testing stage may be omitted. For example, if the Requested PIN is identical to the Authenticating PIN, the inputted PIN can be provided as is to the host system. According to another embodiment of the invention, the input stage may be omitted. For example, upon clicking a pre-defined button at the PDA, the Requested PIN is transmitted to the security token, and therefrom to the host system.

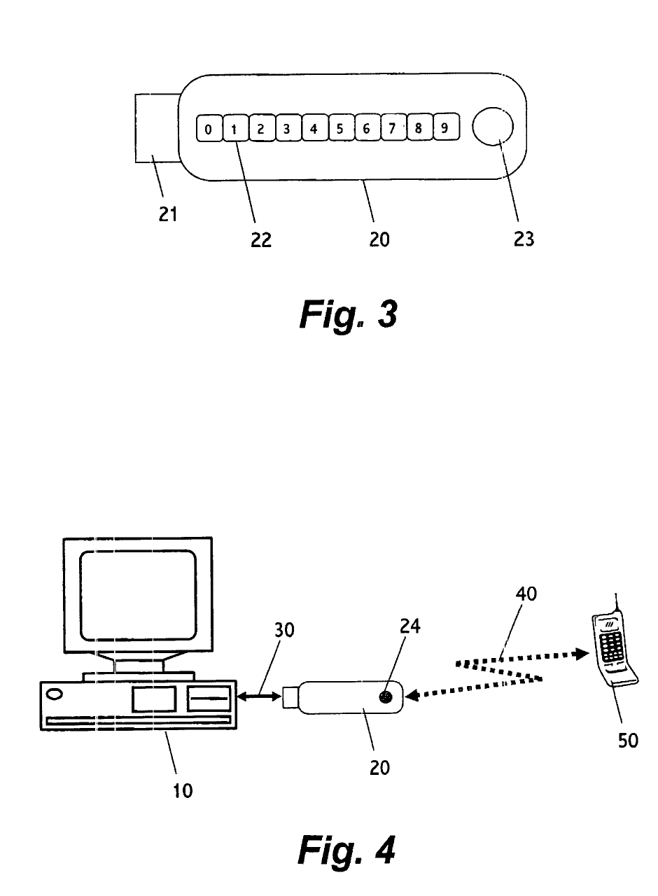

FIG. 3 schematically illustrates a security token coupled with a keypad as input means, according to a preferred embodiment of the invention. By inputting the Authenticating PIN at the keypad 22, and authenticating the user by the processing means of the security token, the authentication process is kept outside the host system, thereby the provision of the Requested PIN and the Authenticating PIN is carried out securely. The token can further comprise an additional button 23, by which the user ends the input session. For example, after plugging the connector 21 (i.e. USB connector) into the mating connector of a host system, the user types the Authenticating PIN at the keypad 22. In order to inform the security token about the termination of the input, the user clicks the button 23 (“Enter Button”).

After providing a correct PIN, the token 20 releases the key to the host system. Of course, instead of sending a pre-stored PIN within the security token, the PIN can be generated by some computational operations, and then released to the host system.

FIG. 4 schematically illustrates elements involved in a PIN Entry process, according to another preferred embodiment of the invention. Instead of providing the security token 20 with input means, the security token is provided with communication means to the mobile phone 50. For example, both the security token 20 and the mobile phone 50 support the same WPC (Wireless Proximity Communication) protocol, such as Bluetooth, IrDA (infrared protocol) and so forth. Thus, instead of typing the PIN on the security token, which may be inconvenient due to its small size, the user may type the PIN on the mobile phone. The associated values with the clicked keys are transmitted via the WPC channel to the security token. Such a mechanism is described in more details in the pending application, referenced at the attorney's docket as 2808/5.

In this case, the security token is coupled with a testing facility, while the input facility is carried out by an external device to the security token, and therefore the security token is provided also with communication means to said external device.

Of course the testing can be carried out by the mobile phone, instead of by the security token. Nowadays mobile phones are coupled with processing and storage means, by which the testing can be carried out. After authenticating the user, the mobile phone sends a signal through the WPC channel to the security token, in which the result of the authentication test is acknowledged. A high security level can be obtained by securing the WPC transmission (e.g. by PKI).

According to another preferred embodiment of the invention, the token is provided with biometric input and analysis means, for authenticating the user. For example, the security token may comprise a microphone through which the user inputs his voice, and means for analyzing the sampled voice in order to determine if the sampled voice belongs to an/the authorized user. Those skilled in the art will appreciate that there are a variety of methods for carrying such an analysis. Typically the sample is converted to a digital form, then some characteristics of the biometric sample are obtained from the sample, which are compared with the characteristics of the sample of the authorized person. Of course some statistical tests can be implemented in order to estimate the probability that the sample belongs to an authorized user.

Another example of biometric input is fingerprint. For implementing such a mechanism, the security token has to be coupled with fingerprint reader and fingerprint analysis means.

According to a preferred embodiment of the invention, in order to prevent “hacking” the security token, a smartcard chip is used for performing the computation and/or storage activities. A smartcard chip is characterized by the difficulty of retrieving its content by an unauthorized object. Thus, it can store the PINs, can perform the processing of the authentication test, etc.

The invention can be embodied in other forms and ways, without losing the scope of the invention. The embodiments described herein should be considered as illustrative and not restrictive.

1. A method for securely providing a PIN to a security token being separated from a host system, comprising:
(a) providing means for rendering said PIN, said means being separate to said host system;
(b) rendering said PIN by said means; and
(c) providing the rendered PIN to said security token;
thereby securely providing said PIN to said security token.

2. A method according to claim 1, wherein said means for rendering said PIN being also separated from said security token and conveyed to said security token via data communication means.

3. A method according to claim 1, wherein said rendering said PIN is carried out by one or more operations selected from a group comprising retrieving said PIN from a pre-stored memory, inputting said PIN by a user, inputting a biometric input and converting said input to a PIN, generating said PIN by processing.

4. A method according to claim 3, wherein said inputting said PIN is carried out by the means selected from a group comprising a keyboard, a remote keyboard, a personal handheld device, and biometric input means.

5. A method according to claim 2, wherein said communication means are selected from a group comprising wired communication means, and wireless communication means.

6. A method for securely providing a PIN by a security token to a host system, comprising the steps of
a) providing authenticating means separated from said host system, for authenticating users;
b) authenticating a user by said authenticating means;
c) in response to positively authenticating said user, providing said PIN by said security token to said host system; and/or
d) in response to failing to authenticate said user, sending by said security token to said host system a corresponding failure notice;
thereby securely providing said PIN to said host system.

7. A method according to claim 6, wherein said authenticating a user is carried out by:
inputting an authenticating signal from said user; and
testing if said authenticating signal corresponds to a signal expected from an authentic user.

8. A method according to claim 6, wherein said authenticating a user is fully carried out by said security token.

9. A method according to claim 6, wherein said authenticating a user is partly carried out by said security token, and partly carried out by a separate device to said security token and to said host system.

10. A method according to claim 6, wherein said authenticating a user is carried out by one or more separate devices to said security token

11. A system for securely providing a PIN to a host system through a security token, comprising:
input means, for inputting an authenticating signal from a user to be authenticated; and/or
testing means, for testing the correspondence of said authenticating signal to a signal expected from an authentic user;
said input means and/or said testing means being separate to said host system, thereby securely providing said PIN to said host system.

12. A system according to claim 11, further comprising:
a separate device to said security token, for hosting said input means and/or for hosting said testing means, and communication means for communicating with said security token;
communication means on said security token, for communicating with said separate device.

13.A system according to claim 11, wherein said security token is used as the platform to said input means and/or said testing means

14.A system according to claim 11, wherein said testing means is in the form of an executable computer code.

15.A system according to claim 11, wherein said input means is selected from a group comprising a keyboard, a remote keyboard, a personal handheld device, and biometric input means.

16. A system according to claim 15, wherein said biometric input is selected from a group comprising voice, fingerprint, image, and retina.
